(19) United States
(12) Patent Application Publication
(10) Pub. No.: US 2003/0037234 A1
(43) Pub. Date: Feb. 20, 2003

(54) Method and apparatus for centralizing a certificate revocation list in a certificate authority cluster

(76) Inventors: Christina Fu, Saratoga, CA (US); Ajay Sondhi, San Jose, CA (US)

Correspondence Address: WAGNER, MURABITO & HAO LLP, Third Floor, Two North Market Street, San Jose, CA, 95113, US

(21) Appl. No.: 09/932,298

(22) Filed: Aug. 17, 2001

(51) Int. Cl. H04L 9/00

(52) U.S. Cl. 713/158

(57) ABSTRACT

A method and apparatus for centralizing a certificate revocation list (CRL). Specifically, the present invention describes a method and system for centralizing a CRL in a certificate authority. The certificate authority is comprised of a master server coupled to a plurality of clone servers that form a cluster of servers. Each of the clone servers in the cluster has the capability to provide certificate authority services. The present invention centralizes the CRL at a database accessed by the lightweight directory access protocol that supports a Secure Sockets Layer. A CRL merger service located at the master server maintains the CRL. The master server also receives revocation information coming from the clone servers indicating a certificate has been revoked. Upon receipt of such revocation certificate record, the corresponding certificate is added to the CRL. In this way a centralized CRL is maintained for the entire certificate authority cluster of servers.

### BACKGROUND OF THE INVENTION

1. Field of the Invention

The present invention relates to the field of digital certificates. More particularly, the present invention relates to the centralization of certificate revocation lists in certificate authority clusters.

2. Related Art

Digital certificates are widely used over communication networks and in the field of electronic commerce for document and identity authentication purposes. In general, such digital certificates are used to certify the identity of an entity in the digital world, particularly as defined by the public key infrastructure (PKI). In any PKI, a certificate authority (CA) is a trusted entity that issues, renews, and revokes certificates. An end entity (EE) is a person, router, server, or other entity that uses a certificate to identify itself.

To participate in a PKI, an end entity must enroll, or register, into the PKI system. The end entity typically initiates enrollment by giving the CA some form of identification and a newly generated public key in the form of a “certificate request.” The CA uses the information provided to authenticate, or confirm the identity. In addition to authenticating the end entity, the CA uses the public key to ensure “proof of possession,” that is, as cryptographic evidence that the certificate request was signed by the holder of the corresponding private key. Finally, the CA issues a “certificate” that is associated with the end entity'identity and its associated public key. The CA signs the certificate with the CA's own private signing key. By signing, the CA is authorizing the identity of that particular certificate and public key.

As digital certificates are issued and used, they often are either revoked for various reasons. Revocation can be defined as the removal of a certificate's validity prior to its certificate expiration date. A typical example would be when an employee holding a private key on the part of a corporation leaves that corporation. In that case it would be necessary for certificates associated with that private key to be revoked. Otherwise, that person, or any other person holding the private key, with the proper access knowledge, could perform unauthorized transactions on the part of the corporation.

Many other situations may require the placement of a certificate on the CRL. For example, each of the following cases illustrate situations involving revoked certificates: when the relationship between an issuing party and an organization is severed or suspended, an issuing authority ceases to operate, there is suspected private key compromise, a certificate is no longer required by the client, etc.

In other situations, digital certificates may be revoked or placed on hold pending some future event. In such a case, a user may have misplaced a private key, associated with a particular certificate, and is currently searching for it. Also, a user may have forgotten the password needed to access the private key. In that case, the associated digital certificate is revoked until the password issue is resolved. Additionally, a user may go on vacation, and requests that a digital certificate associated with the user's private key be revoked until the user's return from vacation.

A fundamental requirement of PKI is to maintain a path or chain of trust. It is therefore essential to have a mechanism by which digital certificates can be verified as to its validity. One solution amongst many standards in use today is the Certificate Revocation List (CRL). The CRL is a published data structure that is periodically updated. The CRL contains a list of revoked certificate serial numbers. The CRL is time-stamped and digitally signed by the CA who issues the certificates, or other third party entities, such as a revocation service. CRLs are currently defined in the X.509 standard and its various versions.

Prior Art FIG. 1 depicts a communication system network 100 that utilizes a digital certificate and a CRL. In system 100, a user terminal 104 may request via a network 108, a digital certificate from a CA 112. The CA 112 generates and issues the certificate, which is returned to the user terminal 104. The user terminal 104 can then utilize the digital certificate to carry out transactions with another entity, such as, remote server 116. Such transactions may include financial transactions or any other transaction in which the identity of the user terminal 104 should be reliably authenticated.

When user terminal 104 sends the digital certificate to the remote server 116, during verification of the chain of trust, the remote server 116 can inspect the digital certificate against a list of revoked certificates (the CRL) that is stored by the remote server 116. In the event remote server 116 has not obtained a recent CRL, one can be requested from the CA 112. The CA 112 then either generates a new CRL or sends the most recently generated CRL to the remote server 116. Remote server 116 can then determine whether or not the digital certificate sent by user terminal 104 is valid. Thus, remote server 116 can authenticate the user terminal 104 and determine whether or not to authorize a particular transaction at hand.

To achieve greater scalability, a web server cluster that comprises a Certificate Authority is one solution for meeting the growing need for CA services. FIG. 2 of the prior art illustrates a cluster network CA 200. The CA cluster 200 is comprised of a plurality of clone CA servers, e.g. CA clone-1 210, CA clone-2 210, on up to CA clone-n 230. Each of the CA clone servers is capable of conducting all the CA services, such as, certificate enrollment, certificate renewal, certificate revocation, publishing CRLs, etc. As such, each of the CA clone servers of the CA cluster 200 is capable of issuing certificates verified by the same CA signing certificate associated with the CA cluster 200.

In the CA cluster 200, each of the CA clones maintain and manage an independent set of certificates. For example, the CA cluster 200 may manage up to 1000 certificates. The CA clone-1 210 may manage certificates with serial numbers between 1 to 200. The CA clone-2 220 may manage certificates with serial numbers between 201 to 400, and so on. Finally, the CA clone-n 230 may manage certificates with serial numbers between 801 to 1000. Each of the CA clone servers in the CA cluster 200 perform all of the services associated with their assigned certificate serial numbers, including issuing certificates, renewing certificates, revoking certificates, etc.

Further, the cluster feature of CA cluster 200 allows for scalability. In the first case, each of the CA clone servers can expand the number of certificates it issues and manages. For example, a new set of serial numbers can be issued to one or more CA clone servers in a CA cluster to service certificates beyond serial number 1000. Secondly, additional CA clone servers can be added to service certificates beyond serial number 1000. Also, CA clone servers may be taken offline when demand for certificates may lessen, as long as the database information is carefully transferred to an on-line CA clone server for handling renewal and revocation.

A load balancing server 250 is capable of intelligently distributing load across the CA cluster. Also, the load balancing server 250 can control routing of messages to the proper CA clone (e.g., CA clone 210, 220, on up to clone 230). Proper request distribution helps to achieve scalable and predictable cluster performance and functionality.

In this cluster configuration, the CA cluster 200 appears as a single CA to the clients. As such, the CA cluster can have a virtual address.

The CA cluster 200 configuration of Prior Art FIG. 2 has an associated CRL that contains a list of all the pertinent revoked certificates associated with CA cluster 200. In the prior art solution, each of the CA clones (e.g., 210, 220, on up to 230) maintains identical CRLs that pertain to all the revoked certificates in the CA cluster 200. For example, CA clone-1 contains a CRL-1 212, CA clone-2 contains a CRL-2 222, on up to CA clone-n which contains a CRL-n 232. Each CRL is not partitioned, where only the revoked certificates pertaining to the particular clone containing the CRL is stored. Rather, each CRL (e.g. CRLs 252, 212, 222, on up to 232) contains a complete list of revoked certificates associated with the CA cluster 200. Maintenance of identical CRL lists in each of the servers in the CA cluster configuration is implemented in order to comply with the Internet X.509 standard that requires all CRLs to be complete.

Further, maintenance of only partial CRLs that pertain only to certificates with serial numbers that are particular to each of the servers in the CA clone cluster would compromise the purpose of the CRL. For example, when a request for a CRL comes in from a third party remote server, such as remote server 116 of Prior Art FIG. 1, the request could be distributed to any one of the servers in the CA cluster 200. Since each of the servers in the CA cluster 200 would only contain partial CRLs pertaining to certificates with serial numbers associated with the server servicing a CRL request, the CRL would be incomplete. A possible revoked certificate that is important to the requester would not be included in the partial CRL list. Therefore, it would be necessary to maintain identical CRLs at each of the servers in the CA cluster 200.

However, maintenance of identical CRLs at each of the servers in the CA cluster 200 would limit increased scalability of the cluster. With increased number of entries in a CRL, increased processing is necessary to maintain each of the CRLs in the CA cluster 200 to ensure their accuracy. Also, copying over key and certificate files, along with other information pertaining to these files, such as configuration, is a manual process and can be time consuming and tedious. This increased computer processing wastes important central processing unit (CPU) resources at each of the CA clones in the CA cluster 200. Furthermore, duplicating the CRL at each server in CA cluster 200 in a scalable environment wastes valuable memory resources, especially when the cluster becomes overly large.

As digital certificates find wider use, the number of such certificates issued has increased dramatically. With this increase comes an associated increase in the number of entries in a Certificate Revocation List. Accordingly, a need exists to overcome the lack of scalability in producing multiple CRLs at CA clones. Also, a need exists to satisfy the Internet X.509 Public Key Infrastructure Certificate and CRL Profile (RFC 2459) communication standard that requires complete CRLs be maintained.

### SUMMARY OF THE INVENTION

Embodiments of the present invention disclose a method and system for centralizing a certificate revocation list (CRL) in a certificate authority cluster of servers. Also, one embodiment of the present invention overcomes scalability issues that arise when maintaining and creating multiple CRLs in a CA cluster. Additionally, another embodiment of the present invention satisfies the X.509 Public Key Infrastructure Certificate and CRL Profile (RFC 2459) communication standard requiring maintenance of a complete CRL.

These and other benefits and advantages of the present invention will no doubt become obvious to those of ordinary skill in the art after having read the following detailed description of the preferred embodiments which are illustrated in the various drawing figures.

Specifically, one embodiment of the present invention describes a method and system for centralizing a single CRL in a certificate authority cluster. The certificate authority is comprised of a CA master server coupled to a plurality of CA clone servers that form a cluster of servers (CA cluster). The CA master server provides a CRL merger service which maintains a single CRL for the CA cluster. Each of the CA clone servers in the CA cluster has the capability to provide CA services.

In one embodiment, the present invention centralizes the CRL at a database accessed by the lightweight directory access protocol (LDAP) with Secure Sockets Layer (SSL) capability. The CA clone master maintains the single CRL for the CA cluster via a CRL merger service. In this way, each individual CA clone is alleviated from the need to generate CRLs that are complete in their own right.

Each CA clone sends revocation information regarding a certificate upon a revocable event to the CA merger. Depending on the contents of the revocation information, upon receipt of the publication of a revocation certificate record regarding a certificate, the CA clone master through the CRL merger service adds or removes the serial number of the revoked certificate to the single CRL. In this way a single, centralized CRL is maintained for the entire CA cluster of servers.

### BRIEF DESCRIPTION OF THE DRAWINGS

PRIOR ART FIG. 1 is a block diagram of a public key infrastructure (PKI) system using digital certificates.

PRIOR ART FIG. 2 is a block diagram of a Certificate Authority (CA) cluster network creating and maintaining numerous identical Certificate Revocation Lists (CRLs).

FIG. 3 is a logical block diagram of a CA clone master with CRL merger service capabilities, in accordance with an embodiment of the present invention.

FIG. 4 illustrates a block diagram of an exemplary CA cluster network having a single, centralized CRL, in accordance with one embodiment of the present invention.

FIG. 5 is a flow diagram illustrating steps in a computer implemented method for centralizing a CRL in a CA cluster network, in accordance with an embodiment of the present invention.

### DETAILED DESCRIPTION OF THE INVENTION

Reference will now be made in detail to the preferred embodiments of the present invention, a method and system for centralizing a Certificate Revocation List (CRL) in a Certificate Authority (CA) cluster, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” or “processing,” or “computing,” or “translating,” or “calculating,” or “determining,” or “scrolling,” or “displaying,” or “recognizing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

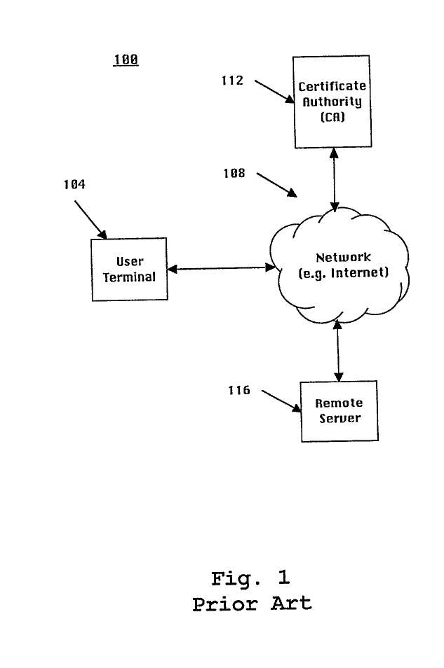

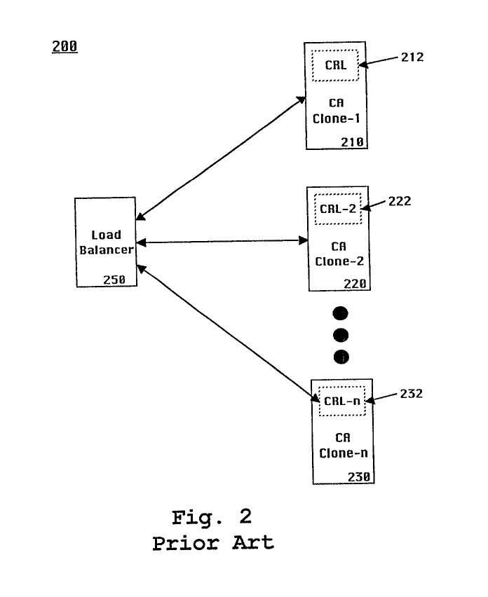

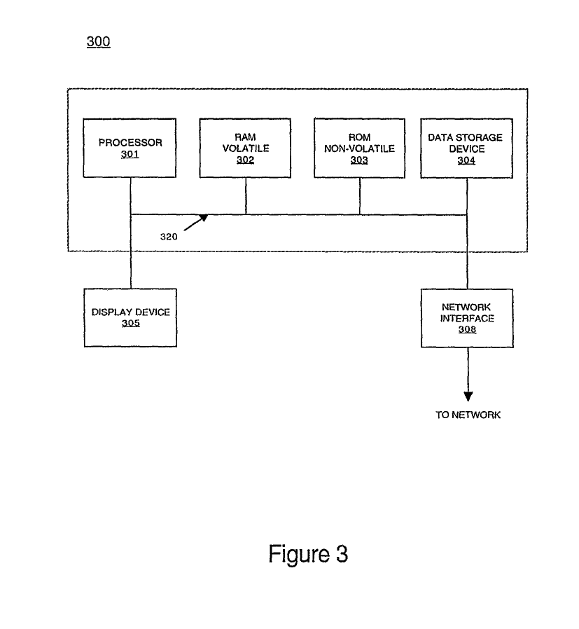

Referring now to FIG. 3, embodiments of the present invention are comprised of computer-readable and computer-executable instructions which reside, for example, in computer-readable media of an electronic system, such as a CA clone master that manages the CRL merger service. FIG. 3 is a block diagram of exemplary interior components of an exemplary electronic system 300 upon which embodiments of the present invention may be implemented.

FIG. 3 illustrates circuitry of an exemplary electronic system 300. Exemplary electronic system 300 includes an internal address/data bus 320 for communicating information, a central processor 301 coupled with the bus 320 for processing information and instructions, a volatile memory 302 (e.g., random access memory (RAM), static RAM dynamic RAM, etc.) coupled with the bus 320 for storing information and instructions for the central processor 301, and a non-volatile memory 303 (e.g., read only memory (ROM), programmable ROM, flash memory, EPROM, EEPROM, etc.) coupled to the bus 320 for storing static information and instructions for the processor 301.

With reference still to FIG. 3, an optional signal Input/Output device 308 is coupled to bus 320 for providing a communication link between electronic system 100 and a network environment. As such, signal Input/Output (I/O) device 308 enables the central processor unit 301 to communicate with or monitor other electronic systems or analog circuit blocks that are coupled to the electronic system 300. The electronic system 300 is coupled to the network (e.g., the Internet) using the network connection, I/O device 308, such as an Ethernet adapter coupling the electronic system 300 through a fire wall and/or a local network to the Internet.

An output mechanism may be provided in order to present information at a display 305 or print output for the electronic system 300. Similarly, input devices such as a keyboard (not shown) and a mouse (not shown) may be provided for the input of information to the electronic system 300.

Electronic system 300 may also include various forms of disc storage 304 for storing large amounts of information, such as the list of certificates issued and the most recent Certificate Revocation List, as well as any other information that is required.

Centralizing A Certificate Revocation List in A Certificate Authority Cluster

This disclosure describes a method and apparatus for centralizing a CRL in a CA cluster network. Embodiments of the present invention address the problem of a CA cluster network reaching a limit on its available CPU and memory resources in maintaining identical CRLs that are complete at each CA clone server. In addition, embodiments of the present invention satisfy the Internet X.509 Public Key Infrastructure Certificate and CRL Profile (RFC 2459) communication standard.

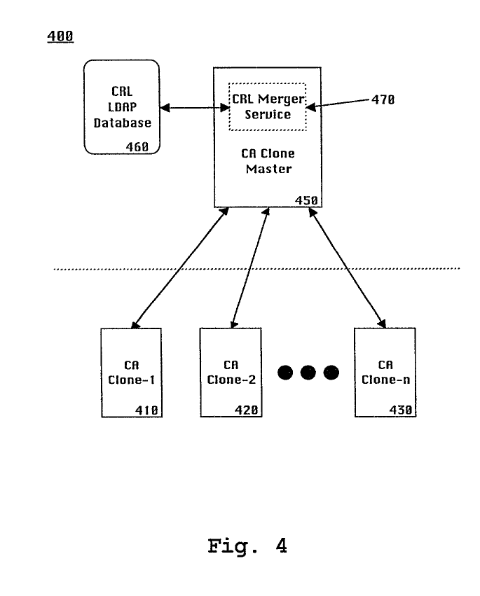

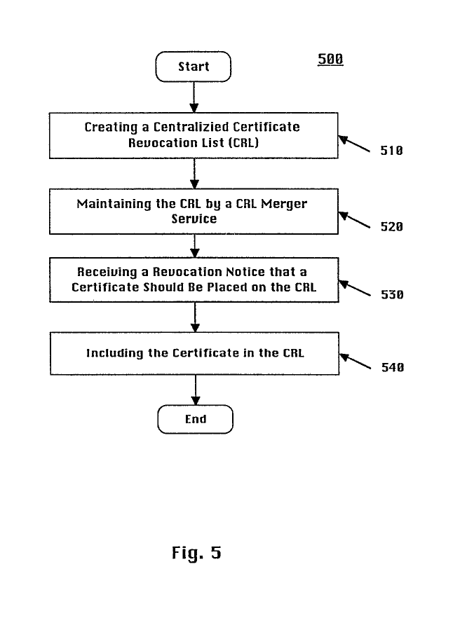

The method outlined in process 500 of FIG. 5 in combination with FIG. 4 provides a CRL that is compliant with the X.509 communication standard and maintains scalability features of a CA cluster network. FIG. 5 is a flow diagram illustrating steps in a computer implemented method for centralizing a CRL in a CA cluster network, in accordance with one embodiment of the present invention.

The present embodiment begins process 500 by creating a single CRL that is centralized. The CRL is associated with a CA cluster network in step 510. An exemplary CA cluster network 400 is illustrated in block form as shown in FIG. 4. The CA cluster 400 is comprised of a plurality of clone CA servers, e.g. CA clone-1 410, CA clone-2 420, on up to CA clone-n 430. Further, a CA clone master server 450 manages and maintains the CRL associated with the CA cluster 400. The CA clone master server manages the CRL through a CRL merger service 470 located at the CA clone master 450. By separating the services involved with maintaining and managing the CA CRL at a centralized location, the resources for each of the CA clones (e.g., 410, 420, on up to 430) are more efficiently utilized to provide for CA services other than CRL management. This ensures increased scalability for the CA cluster, and also is fully compliant with the Internet X.509 completeness requirement.

The components of the CA cluster network are coupled via a suitable communication network (e.g. local area network, or wide area network, etc.). In this way each of the CA clones can be located on a separate server computer in various geographical locations.

Also, each of the CA clone servers is capable of conducting all the CA services, such as, certificate enrollment, certificate renewal, certificate revocation, etc. As such, each of the servers of the CA cluster 400 is capable of issuing certificates verified by the same CA signing certificate associated with the CA cluster 400. A load balancer (not shown) intelligently distributes new requests for certificates amongst the servers in CA cluster 400 in order to achieve proper load balancing and scalability of CA cluster 400.

In the CA cluster 400, each of the CA clones maintains and manages an independent set of certificates. For example, the CA cluster 400 may manage up to 1000 certificates at a particular time. The CA clone-1 410 may manage certificates with serial numbers between 0 to 201. The CA clone-2 420 may manage certificates with serial numbers between 201 to 400, etc. The CA clone-n 430 may manage certificates with serial numbers between 801 to 1000. Each of the CA servers in the CA cluster 400 perform all of the services associated with their assigned certificate serial numbers, including issuing certificates, renewing certificates, revoking certificates, etc.

Further, the cluster feature of CA cluster 400 allows for scalability. In the first case, each of the CA clone servers (e.g., 410, 420, on up to 430) can expand the number of certificates it issues and manages. For example, a new set of serial numbers can be issued to one or more CA clone servers in a CA cluster to service certificates beyond serial number 1000. Secondly, additional CA clone servers can be added to service certificates beyond serial number 1000. Also, CA clone servers may be taken off-line when demand for certificates may lessen, as long as the database information is carefully transferred to an on-line CA clone server for handling renewal and revocation.

Returning to FIG. 5, the embodiment illustrated by process 500 in step 520 maintains a CRL 460, that is associated with the CA cluster network 400, by a CA merger service 450. The CRL 460 is associated with a directory server (not shown). Communication between the CA clone master 450 and the directory server occurs via a Lightweight Directory Access Protocol (LDAP) in one embodiment of the present invention. The CRL merger service 470 creates and maintains the CRL 460, and responds to requests regarding the CRL 460 in order to centralize the CRL generation. In one embodiment, the CRL merger service 470 is a module located on the CA clone master 450. Also, in another embodiment, the CA clone master 450 which runs the CRL merger service 470 is a separate system independent of the CA clones in CA cluster network 400 in order to free up resources at each of the CA clone servers (e.g., 410, 420, on up to 430).

By locating the CRL 460 in a centralized location, the X.509 communication standard is more easily satisfied. A single and complete CRL managed by the CA clone master 450 via the CRL merger service 470 satisfies the X.509 requirement that all CRLs be complete.

FIG. 4 discloses a CRL merger service 470 that runs separately from the CA clones (e.g., 410, 420, on up to 430) in the network 400. In this way, the burden of generating CRLs at each of the CA clones (e.g., 410, 420, on up to 430) is shifted from the CA clones to one location: the CA clone master 450 running the CRL merger service 470. It is therefore essential, in one embodiment, to have the CRL merger 470 as a separate entity that can be potentially run on a separate machine.

The CRL merger service 470 of FIG. 4 is focused solely on creating and maintaining the CRL 460. In this way, the CA clone master 450 running the CRL merger service 470 is not burdened with other unnecessary connections or services. For example, in one embodiment of the present invention, the CRL merger service 470 maintains a database via a Lightweight Directory Access Protocol (LDAP). In one embodiment, the CA clone master 450 communicates with the directory server (not shown) associated with the CRL 460 via LDAP that supports Secure Sockets Layer (SSL). The LDAP database is ultimately where revoked certification records and the CRL 460 are stored. In another embodiment, the CRL merger service 470 performs its functions through a servlet. The servlet could be located at the CA master 450 of FIG. 4.

The CRL merger service 470 of FIG. 4 does not actively seek out revoked certificates from each of the CA clones in CA cluster 400. Instead, a revocation event at any of the CA clones triggers the information regarding the revoked certificate to be sent directly to the CA clone master 450 and the CRL merger service 470. Thus, the CA clone handling the certificate associated with the revocation event initiates communication with the CA clone master 450 in order to notify the CRL merger service 470 of FIG. 4 of the revocation event. In this way, the CA clone sends revocation information, associated with a certificate, to the CRL merger service 470. The revocation information is in the form of a revocation certificate record in one embodiment.

Referring back to FIG. 5, the embodiment showing process 500 illustrates the CRL merger service 470 communicating with the CA clone handling the revoked certificate. In step 530, the present embodiment receives the revocation information (e.g., notification of a revocation certificate record) from the CA clone that the certificate in question has been revoked and should be placed on the CRL 460.

It is important to note, that the communication between the CRL merger service 470 and the CA clone handling the certificate associated with the revocation event includes all messages relating to the service provided in maintaining a CRL 460. This includes revocation events that not only put certificates onto the CRL 460, but also removes the certificate from the CRL 460. In other words, the revocation event may trigger the CA clone handling the event to communicate with the CRL merger service 470 in order to handle revoked or unrevoked certificates, and on-hold or off-hold certificates.

In step 540 of FIG. 5, the embodiment illustrating process 500 performs the necessary action in relation to the revocation information (e.g., publication of the revocation certificate record) and the associated revocation event. For example, if the revocation information indicates the revocation event revokes a certificate, the CRL merger service 470 will add the serial number of the revoked certificate to the CRL 460. If the revocation information indicates the revocation event unrevokes a certificate, then the CRL merger service 470 will remove the serial number of a revoked certificate, that previously was included in the CRL 460, from the CRL 460.

In addition, certain certificates may be placed on the CRL 460 temporarily, and are revoked certificates pending some future event. These certificates are effectively on-hold until further notice. This may address certificates whose keys are not stolen or compromised, but possibly just misplaced. In that case, if the revocation information pertaining to a revocation event indicates that the certificate is on-hold, the CRL merger service 470 will add the serial number of the on-hold certificate to the CRL 460. Also, if the revocation information pertaining to a revocation event indicates that the certificate is off-hold (e.g., the certificate has been found and is uncompromised), then the CRL merger service 470 will remove the serial number of the certificate from the CRL 460.

The respective CA clones and the CRL merger service 470 of FIG. 4 communicate over a secure communication channel, in one embodiment of the present invention. In other words, the protocol used for transmitting certificate information from CA clones to their CA merger 470 is through a secure protocol over a secure communication channel.

In another embodiment of the present invention, the CA clones conducts secure sockets layer (SSL) client authentication with the CRL merger service 470 over the secure communication channel before any communication is conducted between the respective CA clone and the CRL merger service 470. Those skilled in the art understand that other well known authentication methods can be utilized with embodiments of the present invention.

Referring back to CA cluster network 400 in FIG. 4, each of the CA clones (e.g., 410, 420, on up to 430) no longer generate a separate and complete CRL. Instead, whenever there is a revocation event, the CA clones handling the revocation event generates the necessary revocation information regarding a particular certificate to be sent to the CRL merger service 470. In other words, the CA clone publishes a revocation notice regarding a particular certificate record that is received by the CRL merger service 470. The CRL merger service 470 then publishes or places the serial number of the revoked certificate on the CRL 460 database. In this way, important CPU and memory resources are liberated from generating and maintaining the separate and complete CRLs at each of the CA clones in CA cluster network 400. As such, since the generation of and services provided for a single CRL 460 is centrally located in a CA clone master 450 whose sole operation is to run and manage the CRL merger service 470, the CA cluster network 400 is fully scalable.

In addition, each individual CA clone in exemplary CA cluster 400 has the ability to detect any missed publication of revocation certification records, or revocation notice, in accordance with one embodiment of the present invention. These missed publications indicate the revocation notice was not received by the CRL merger service 470, and more importantly, the certificate was not put onto the CRL 460 database. In this manner, the revocation certificate record can be periodically resent by the CA clone until the CRL merger 470 receives the revocation certificate record, and publishes the record by putting the serial number of the revoked certificate into the CRL 460 database.

In another embodiment, when a CA clone in the CA cluster network 400 is restarted, the CA clone reads from a reliable resource that indicates which revoked certificates were unpublished. In this way, the CA clone can initiate a process whereby unpublished revocation certificate records will be resent by the CA clone to the CRL merger service 470 for publication. In one embodiment, publishing records are kept in the certification record itself.

In another embodiment of the present invention, if CRL merger service 470 is restarted, the CRL merger service 470 does not need to initiate any communication with the CA clones in the CA cluster network 400 of FIG. 4. During the shutdown period, the CA clones will continue to send revocation certificate records to the CRL merger service 470 of FIG. 4. Since all the CA clones know exactly which records were received and which records were not received by the CRL merger service 470, attempts will be made continuously made until, either, the CA clone has been shut down, or the CRL merger service 470 is up and running again. This will continue until the revocation certificate record is successfully received by the CRL merger service 470 and the record is published in the CRL 460 database.

In addition, each of the CA clones should remember which last publication of a revocation notice, revocation certificate record, was successful. As such, all unpublished revocation certificate records will be kept in memory (e.g., cache memory) for retransmission.

To avoid searching through the entire CRL 460 database for unpublished revocation certificate records, under graceful shutdown of the CRL merger service 470, the CA clone can be allowed to store its unpublished revocation certificate records, which are stored in cache memory, to a more permanent storage location.

In still another embodiment of the present invention, a CA can change configuration from a self-sufficient (CRL generating) CA into a CA clone, such as those illustrated in FIG. 4. The CA clone relies on a CRL merger service (e.g., CRL merger service 470) to generate the CRL 460. Also, the reverse is also possible, where a CA clone can change configuration to a self-sufficient CA. This is most useful when in retrofitting from a single CA environment to a multiple cloned CA cluster environment. In that case the original single CA needs to be reconfigured into a CA clone. A mechanism is needed to search through its database for unpublished revocation certificate records and resend them to the CA clone master running the CRL merger service (e.g., merger service 470).

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random access Memory (RAM) devices; optical storage elements, magnetic storage elements, magneto-optimal storage elements, flash memory, core memory and/or other equivalent storage technologies without departing from the present invention. Such alternative storage devices should be considered equivalents.

While the methods of embodiments illustrated in process 500 show specific sequences and quantity of steps, the present invention is suitable to alternative embodiments. For example, not all the steps provided for in the method are required for the present invention. Furthermore, additional steps can be added to the steps presented in the present embodiment. Likewise, the sequences of steps can be modified depending upon the application.

Embodiments of the present invention, centralizing a Certificate Revocation List in a Certificate Authority cluster network, is thus described. While the present invention has been described in particular embodiments, it should be appreciated that the present invention should not be construed as limited by such embodiments, but rather construed according to the below claims.

What is claimed is:

1. A method of creating a certificate revocation list (CRL), comprising:
a) creating a single CRL that is centralized, said single CRL associated with a certificate authority (CA) comprising a master server coupled to a plurality of CA clone servers;
b) maintaining said single CRL with said master server;
c) receiving notice, from one of said plurality of CA clone servers, at said master server containing revocation information regarding a certificate; and
d) updating said single CRL according to said revocation information.

2. The method of creating a CRL as described in claim 1, wherein step d) comprises:
adding said certificate to said single CRL when said revocation information indicates said certificate is revoked, said revocation information associated with a revocation event occurring at one of said plurality of CA clone servers.

3. The method of creating a CRL as described in claim 1, wherein step d) comprises:
removing said certificate from said single CRL when said revocation information indicates said certificate is valid, said revocation information associated with a revocation event occurring at one of said plurality of CA clone servers.

4. The method of creating a CRL as described in claim 1, further comprising:
maintaining said single CRL with a CRL merger service module located at said master server.

5. The method of creating a CRL as described in claim 1, further comprising:
sending said notice over a secure communications channel.

6. The method of creating a CRL as described in claim 5, further comprising:
at said one of said cluster of servers, performing secure sockets layer (SSL) client authentication over said secure communications channel before sending said notice over said secure communications channel.

7. The method of creating a CRL as described in claim 1, further comprising:
transmitting said single CRL that is updated to a recipient over a communication network.

8. The method of creating a CRL as described in claim 1, further comprising:
providing certificate authority services not including maintaining and managing said single CRL at each of said plurality of CA clone servers.

9. The method of creating a CRL as described in claim 1, further comprising:
storing said CRL in a database accessed via a lightweight directory access protocol (LDAP) that supports a Secure Sockets Layer (SSL).

10. The method of creating a CRL as described in claim 1, further comprising:
at said one of said plurality of clone servers, detecting whether said notice was received at said master server;
repeatedly sending said notice until received by said master server.

11. The method of creating a CRL as described in claim 10, further comprising:
storing said notice if said notice was not received at said master server.

12. In a certificate authority (CA) having a plurality of clone servers, a method generating and maintaining certificate revocation list information, comprising:
a) each of said clone servers independently generating revocation information relating to certificates;
b) sending said revocation information to a master server coupled to said plurality of clone servers; and
c) maintaining a single centralized certificate revocation list (CRL) based on said revocation information from said plurality of clone servers, said step c) performed by said master server.

13. The method as described in claim 12, further comprising:
d) in response to an inquiry for said CRL, providing said CRL on behalf of said CA, said step d) performed by said master server.

14. The method as described in claim 12, further comprising:
d) based on said revocation information, adding a certificate to said CRL when said revocation information indicates said certificate is revoked.

15. The method as described in claim 12, further comprising:
d) based on said revocation information, removing a certificate from said CRL when said revocation information indicates said certificate is valid.

16. A certificate authority (CA) comprising:
a plurality of clone servers coupled together for providing certificate authority services;
a centralized certificate revocation list (CRL) associated with said CA; and
a master server coupled to said plurality of clone servers for maintaining said centralized CRL based on revocation information from said plurality of clone servers.

17. The CA as described in claim 16, wherein said master server adds a certificate to said centralized CRL after said revocation information by one of said plurality of clone servers indicates that said certificate has been revoked.

18. The CA as described in claim 16, wherein said master server removes a certificate from said centralized CRL after said revocation information by one of said plurality of clone servers indicates that said certificate is valid.

19. The CA as described in claim 16, further comprising:
a secure communication network coupling each of said plurality of clone servers to said master server for providing secure communication when said information is sent between said plurality of clone servers and said master server.

20. The CA as described in claim 16, further comprising:
a lightweight directory access protocol (LDAP) database that is coupled to said master server for storing said centralized CRL.

21. The CA as described in claim 16, further comprising:
a CRL merger service module located at said master server for maintaining said CRL.

22. A certificate authority (CA) comprising:
a plurality of clone servers coupled together for providing certificate authority services;
a centralized certificate revocation list (CRL) associated with said CA, said centralized CRL located in a lightweight directory access protocol (LDAP) database; and
a master server coupled to said plurality of clone servers for maintaining said centralized CRL based on revocation information from said plurality of clone servers, said centralized CRL coupled to said merger server.

23. The CA as described in claim 22, wherein said master server adds a certificate to said centralized CRL after said revocation information by one of said plurality of clone servers indicates that said certificate has been revoked.

24. The CA as described in claim 22, wherein said master server removes a certificate from said centralized CRL after said revocation information by one of said plurality of clone servers indicates that said certificate is valid.
